(19) United States
(12) Patent Application Publication
(10) Pub. No.: US 2016/0368634 A1
(43) Pub. Date: Dec. 22, 2016

(54) APPARATUS FOR AUTOMATICALLY FILLING PIPETTE

(71) Applicants: Young Joo LEE, Anyang-si, Gyeonggi-do (KR); F.S. KOREA INDUSTRIES INC., Seoul (KR)

(72) Inventors: Young Joo LEE, Anyang-si (KR); Jae Kwang HWANG, Seoul (KR)

(21) Appl. No.: 14/899,105

(22) PCT Filed: Jul. 4, 2014
(86) PCT No.: PCT/KR2014/005988

§ 371 Date: Dec. 16, 2015

(30) Foreign Application Priority Data
Aug. 14, 2013 (KR) 10-2013-0096689

(51) Int. Cl. B65B 31/02; B01L 3/02

(52) U.S. Cl. CPC B65B 31/02; B01L 3/0241; B01L 2400/0478; B01L 2300/0609; B01L 2200/025

(57) ABSTRACT

According to an apparatus for automatically Ming a pipette of the present invention, a pipette is filled with a substance when being coupled to a container, so a user can easily use it without a specific action for filling the pipette with the substance. Farther, an indicator is exposed through a button to a user when the pipette is filled with the substance, so the user can directly recognize whether the pipette is filled with the substance.

### CROSS-REFERENCE TO RELATED APPLICATION

This application claims the benefit of Korean Application No. 10-2013-0096689 filed on Aug. 14, 2013 with the Korean Intellectual Property Office, the disclosure of which is incorporated herein by reference.

### TECHNICAL FIELD

The present invention relates to an apparatus for automatically filling a pipette, and more particularly, an apparatus for automatically filling a pipette with, a desired substance through thread-fastening to a container.

### BACKGROUND ART

In order to use liquid-state substances such as make-up that is preferably used accurately by a predetermined small amount at a time such as eye cream, the substances were generally independently packed in a predetermined amount to be used each time in capsules and the like in the related art. However, even though substances are independently packed, a relatively large amount of the substances remain in the capsules after users use the substances, so that it is considerably inefficient.

In order to overcome this problem in the individual packing, a configuration that dispenses a substance at each time of use using a dispensing unit having the configuration of a push, pump or a dispensing unit having the structure of a common pipette or a syringe after the substance is put in a container has been proposed.

However, according to a dispensing unit such as a common pipette, the amount of substance sacked and dispensed is different in accordance with the degree of pressing a push unit made of rubber by a uses; so it is impossible or very difficult to dispense accurately the same amount of substance every time of using it.

Further, according to a dispensing unit having the configuration of a syringe, it is used generally for a very small amount around 1 ml, so there is a problem with a configuration in that it is required to make the diameter of a syringe very small or make the stroke of a piston very small and it is also required to sack a substance by pulling the piston of a syringe and then push back the piston of the syringe m order to dispense the substance, so it is very troublesome to use this type of dispensing unit.

Meanwhile, according to a dispensing unit having the configuration of a push pump, although there is the advantage that a predetermined amount of substance can be dispensed every time a button is simply pressed, the entire configuration includes not only the structure for the inside and outside of a pump, but a button, an inlet, an outlet, a spring, and a valve, so it is complicated. Further, since a push pump is usually disposed at the top of a container, a suction tube is generally used to suck a substance, but even if a substance remains in a container, the substance cannot be dispensed in some cases, depending on the position of the suction tube.

### PRIOR ART DOCUMENT

### Patent Document

(Patent Document 1) Korean Patent No. 10-1083263
(Patent Document 2) Korean Patent No. 10-1239027

### DISCLOSURE

### Technical Problem

An object of tie present invention is to provide an apparatus for automatically filling a pipette with a substance through thread-fastening to a container.

### Technical Solution

An apparatus for automatically filling a pipette that is thread-fastened to a container keeping a substance includes; a pipette 10 that is filled with a substance; an inner housing 20 that is combined with the pipette 10, transmits a pressure change due to an operation force by a user to the pipette 10, is thread-fastened to the container, and has a cam contact portion on the outer side; a piston 30 that is combined with the inner-housing 20 and provide a pressure change to the pipette 10 by moving up or down; a piston holder 40 that moves up or down the piston 30 by moving along the cans contact portion 50 by an operation force from a user; a guide housing 60 that is combined with the piston holder 40, guides the piston holder 40 up and down, and is rotated with the piston holder 40 by an operation force from a user such that the piston holder 40 interferes with the cam contact portion 50.

The cam contact portion 50 may have: an upward contact portion 52 formed on the outer side of the inner housing 20 and interfering with the piston holder 40 in contact with the piston holder 40; a downward contact portion 54 formed on the outer side of the inner body, interfering with the piston, holder 40 in contact with the piston holder 40, and disposed under the upward contact portion 32; and an inclined portion 56 connecting the upward contact portion 52 and the downward contact portion 54.

Undercut generating horizontal rotation looking of the piston holder 40 may be further formed concavity on at least any one of the upward contact portion 52 and the downward contact portion 54.

The piston, holder 40 may include a bolder body 42 that relatively vertically moves with the button 70 and where the piston 30 is fixed, the contact bar 45 that radially extends from the holder body 42 and interferes with the cam contact portion 50, and an indicator that protrudes through the button 70 from the holder body 42.

The piston holder 40 may further have a guide protrusion 44 for coupling to the guide housing 60, the guide protrusion 44 may relatively move vertically along the guide housing 60 when operation by a user is provided vertically to the piston bolder 40, and when the piston holder 40 is horizontally rotated by an operation force from the user, the guide protrusion may lock the guide housing 60 and integrally rotate with the guide housing 60.

The inner housing 20 may include: an inner body 22 that is thread-fastened to the container by a thread 21 on the inner side; a pipette fixing portion 23 that is formed, inside the inner body 22, fixes the pipette 10, and communicates with the piston 30; a piston moving portion 24 that is formed on the inner body 22, in which the piston 30 is inserted in close contact with the piston moving portion 24, and provides a pressure change to the pipette 10 when the piston 30 moves up or down; a holder guide portion 26 that is formed on the outer side of the inner body 22 and guides the piston holder 40 moving up and down in contact with the piston holder; and the cam contact portion 50 that interferes with the piston holder 40 when being rotated, by an operation force from a user.

The guide housing 60 may include: a guide body 62 that is combined with the case 80; and a piston rail 66 that is formed on the guide body 62, guides the piston holder 40 vertically moving, and locks horizontal rotation of the piston holder 40 for integral rotation with the piston holder 40.

Another aspect of the present invention provides an apparatus for automatically filling a pipette that is thread-fastened to a container keeping a substance. The apparatus includes: a pipette 10 that is filled with a substance; an inner housing 20 that is combined with the pipette 10, transmits a pressure change due to an operation force by a user to the pipette 10, is thread-fastened to the container, and has a cam contact portion on the outer side; a piston 30 that is combined with the inner housing 20 and provide a pressure change to the pipette 10 by moving up or down; a piston holder 40 that moves up or down the piston 30 by moving along the cam contact portion 50 by an operation force front a user; a guide housing 60 that is combined with the piston holder 40, guides the piston holder 40 up and down, and is rotated with the piston holder 40 by an operation force from a user such that the piston holder 40 interferes with the cam contact portion 50, in which cam contact portion 50 has an upward contact portion 52 formed on the outer side of the inner housing 20 and interfering with the piston holder 40 in contact, with the piston holder 40; a downward contact portion 54 formed on the outer side of the inner body, interfering with the piston holder 40 in contact with the piston holder 40, and disposed under the upward contact portion 52; and an inclined portion 56 connecting the upward contact portion 52 and the downward contact portion 54, the piston holder 40 includes a holder body 42 that relatively vertically moves with the button 70 and where the piston 30 is fixed, the contact bar 45 that radially extends from the holder body 42 and interferes with the cam contact portion 50, an indicator 46 that protrudes through the button 70 from the holder body 42 and a guide protrustion 44 for coupling to the guide housing 60, and the guide protrusion 44 relatively moves vertically along the guide housing 60 when operation from a user is vertically provided to the piston holder 40, and the guide protrusion integrally rotates with the guide, housing 60 by mutually locking the guide housing 60 when the piston holder 40 is horizontally rotated by an operation force from a user.

The inner housing 20 may include: an inner body 22 that is thread-fastened to the container by a thread 21 on the inner side; a pipette -fixing portion 23 that is formed inside the inner body 22, fixes the pipette 10, and communicates with the piston 30; a piston moving portion 24 that is formed on the inner body 22, in which the piston 30 is inserted in close contact with the piston moving portion 24, and provides a pressure change to the pipette 10 when the piston 30 moves up or down; a holder guide portion 26 that is formed on the outer side of the inner body 22 and guides the piston bolder 40 moving up and down in contact, with the piston holder; and the cam contact portion 50 that interferes with the piston holder 40 when being rotated by an operation force from a user, in which the guide housing 60 may include: a guide body 62 that is combined with the case 80; and a piston rail 66 that is formed on the guide body 62, guides the piston holder 40 vertically moving, and locks horizontal rotation of the piston holder 40 for integral rotation with the piston bolder 40.

### ADVANTAGEOUS EFFECTS

According to an apparatus for automatically filling a pipette of the present invention, a pipette is filled, with a substance when being coupled to a container, so a user do not have to perform specific operation to till a pipette with a substance.

Further, according to an apparatus for automatically filling a pipette of the present invention, an indicator is exposed through, a button to a user when the pipette is filled with the substance, so the user can directly recognize whether the pipette is filled with the substance.

### DESCRIPTION OF DRAWINGS

FIG. 1 is a perspective view of an apparatus for automatically filling a pipette according to a first embodiment of the present -invention.

FIG. 2 is a perspective view of the apparatus of FIG. 1, seen from under the apparatus.

FIG. 3 is an exploded perspective view of FIG. 1.

FIG. 4 is a font view of FIG. 1.

FIG. 5 is a cross-sectional view taken along line A-A of FIG. 1.

FIG. 6 is a right side view of FIG. 1.

FIG. 7 is a cross-sectional view taken along the line B-B of FIG. 6.

FIG. 8 is a perspective view illustrating a state when an inner housing illustrated in FIG. 3 is coupled.

FIG. 9 Is another side perspective view of FIG. 8.

FIG. 10 is a front view of FIG. 8.

FIG. 11 is a cross-sectional view taken along line C-C of FIG. 10.

FIG. 12 is a right side view of FIG. 10.

FIG. 13 is a cross-sectional view taken along line D-D of FIG. 13.

FIG. 14 is a perspective view of a guide housing illustrated in FIG. 3.

FIG. 15 is a perspective view of the guide housing of FIG. 14, seen from under the guide housing.

FIG. 16 is a front view of FIG. 14,

FIG. 17 is a cross-sectional view taken along the line E-E of FIG. 16.

FIG. 18 is a right side view of FIG. 14.

FIG. 19 is a cross-sectional view taken along line F-F of FIG. 18.

FIG. 20 is a first exemplary view illustrating operation of FIG. 5.

FIG. 21 is a second exemplary view illustrating operation of FIG. 5,

FIG. 22 is a cross-sectional view of an apparatus for automatically filling a pipette according to a second embodiment of the present invention.

FIG. 23 is an exemplary view illustrating operation of FIG. 22.

### MODE FOR INVENTION

Hereinafter, the present invention will be described in detail with reference to the accompanying drawings.

In describing the present invention, well-known functions or constructions will not be described in detail since they may unnecessarily obscure the understanding of the present invention. It should be noted that even if the same terms are used but they indicate different components, they are not given the same reference, numerals.

The terms described hereafter are terms defined in consideration of the functions in the present disclosure and may be change in accordance with the intention of a user such as an experimenter and a measurer and a custom, so the definition, should be based on the entire description of the present disclosure.

Terms used in the specification, ‘first’, ‘second’, and the likes may be used, to describe various components, but the components are not to be construed as being limited to the terms. The terms are used to distinguish one component front another component. For example, the ‘first’ component may he named the ‘second’ component, and vice versa, without departing from the scope of the present invention. The term ‘and/or’ includes s combination of a plurality of items or any one of a plurality of terms.

Terms used in the present specification, are used only in order to describe specific exemplary embodiments rather than limiting the present invention. As used herein, the singular forms are intended to include the plural forms as well, unless the context clearly indicates otherwise.

Unless otherwise defined, ail terns including technical and scientific terms used herein have the same meaning as commonly understood by one of ordinary skill in the art to which the present invention belongs. It must be understood that the terms defined by the dictionary are identical with the meanings within the context of the related art, and they should not be ideally or excessively formally defined unless the context clearly dictates otherwise.

Further, unless explicitly described otherwise, “comprising” any components will be understood to imply the inclusion of other components rather than the exclusion of any other components.

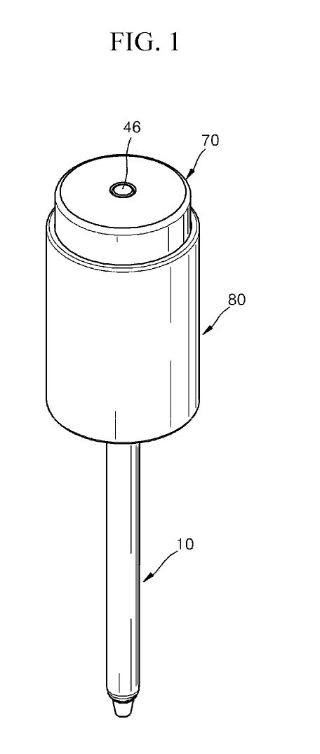

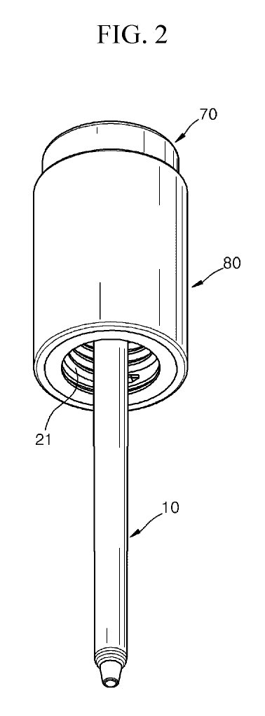

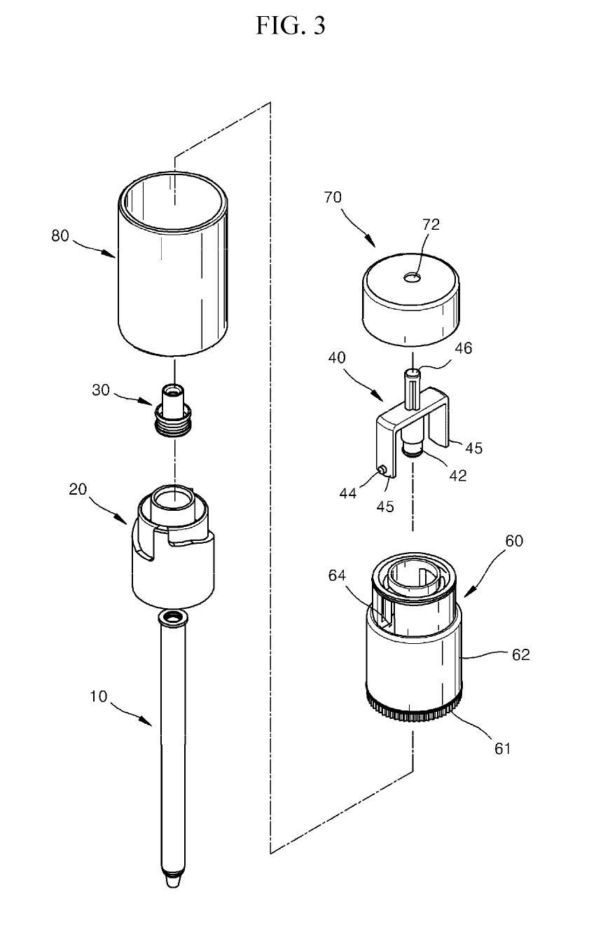

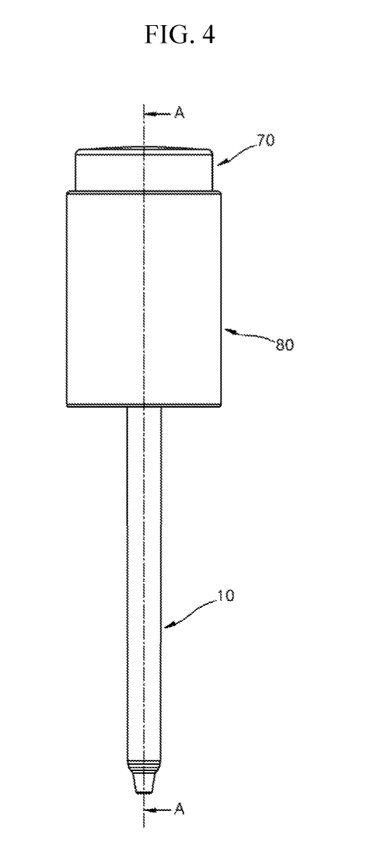

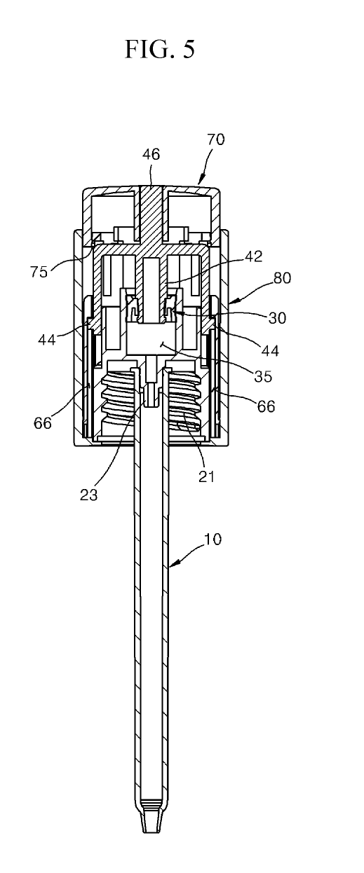

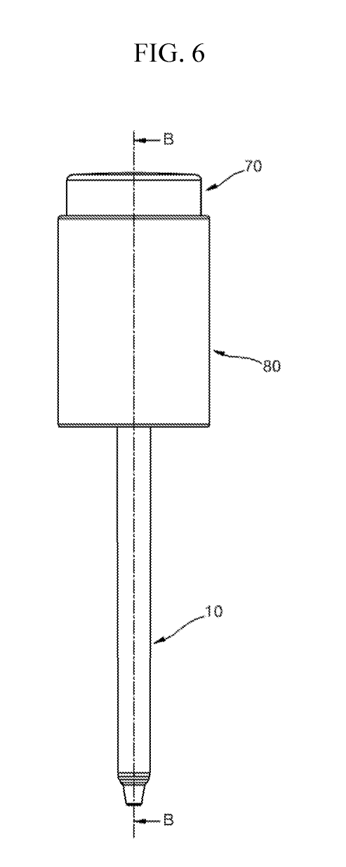

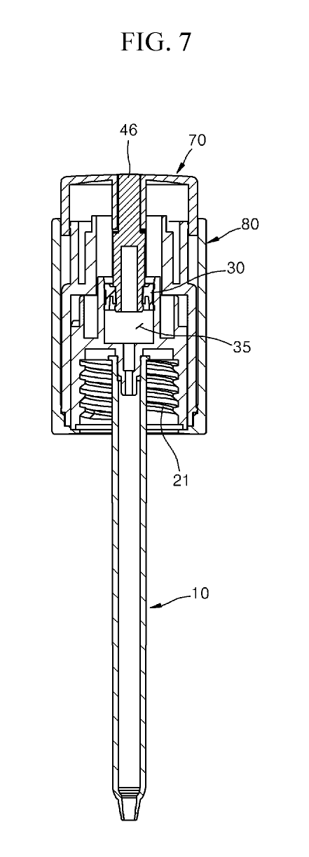

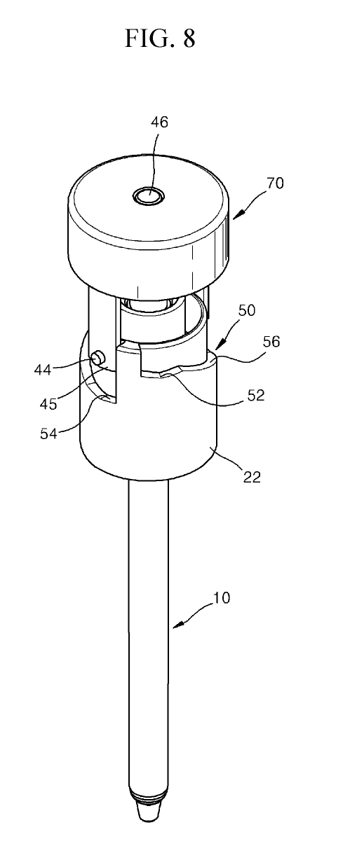

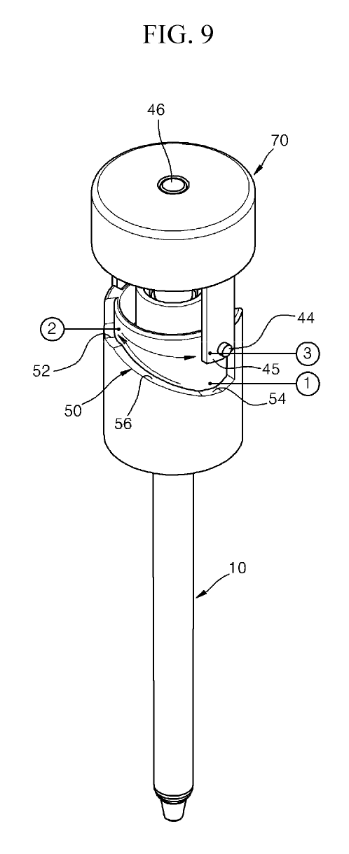

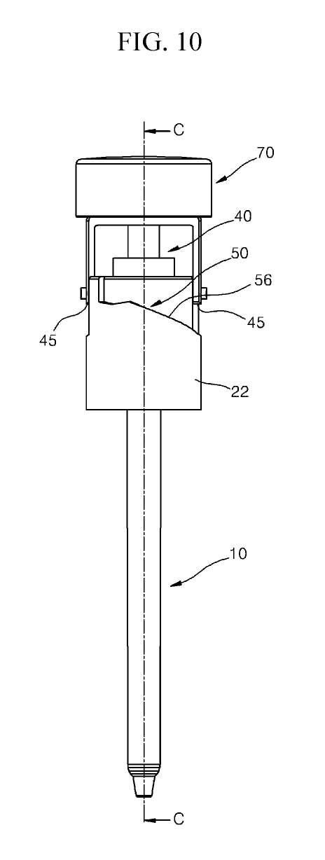

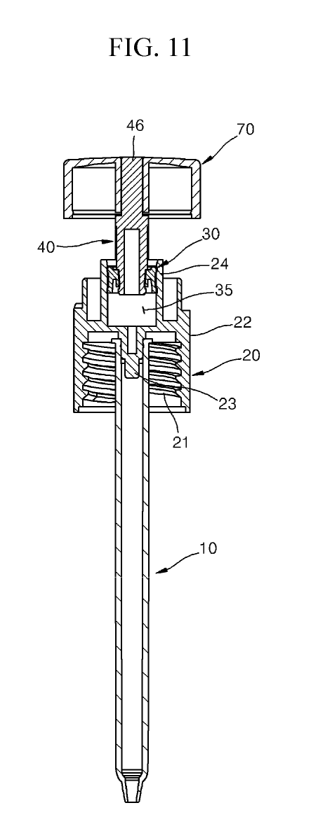

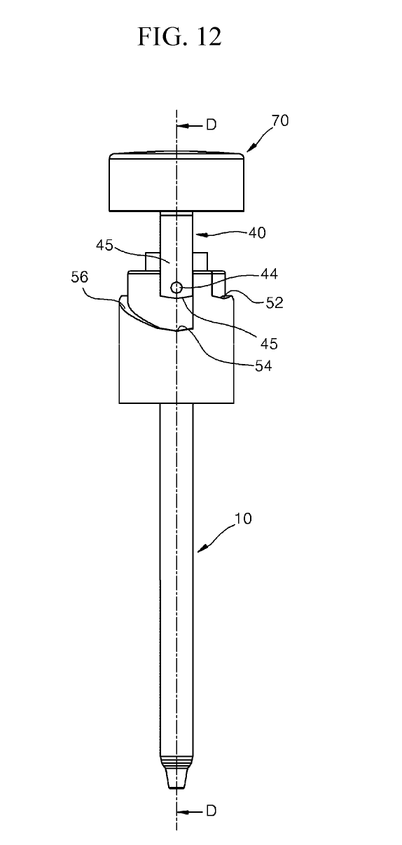

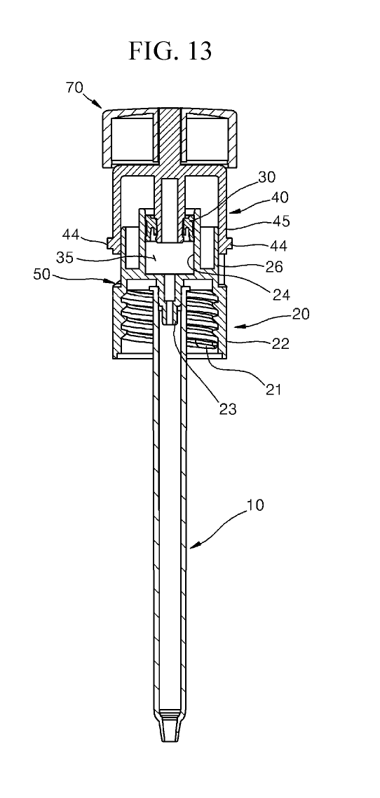

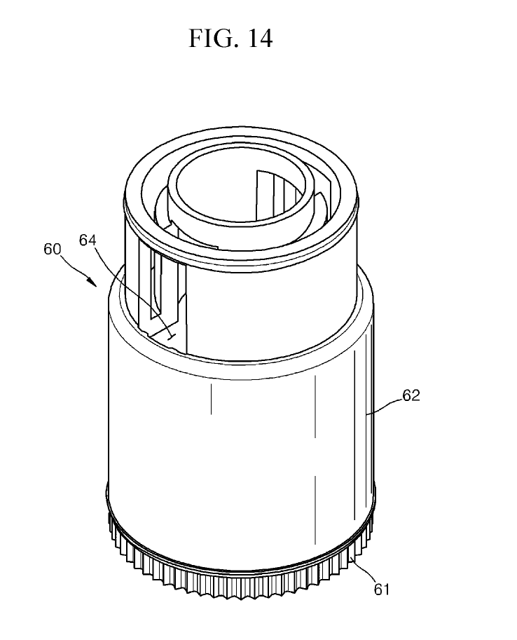

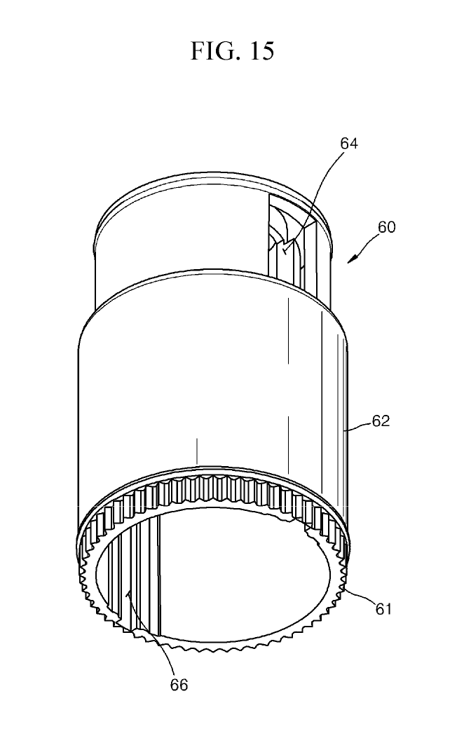

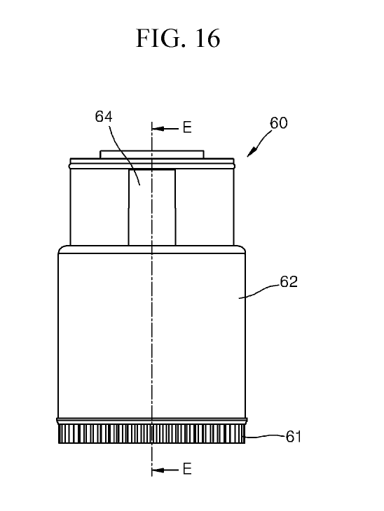

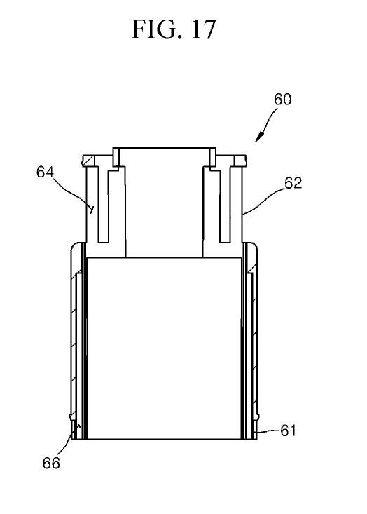

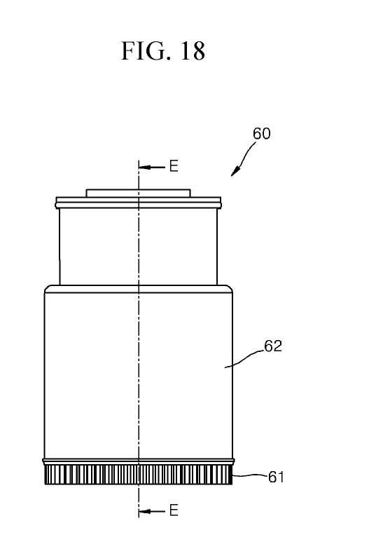

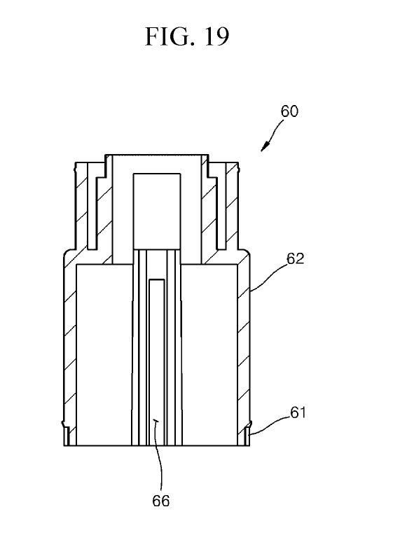

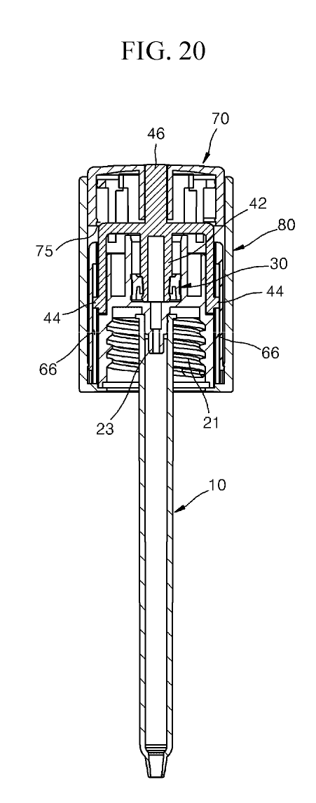

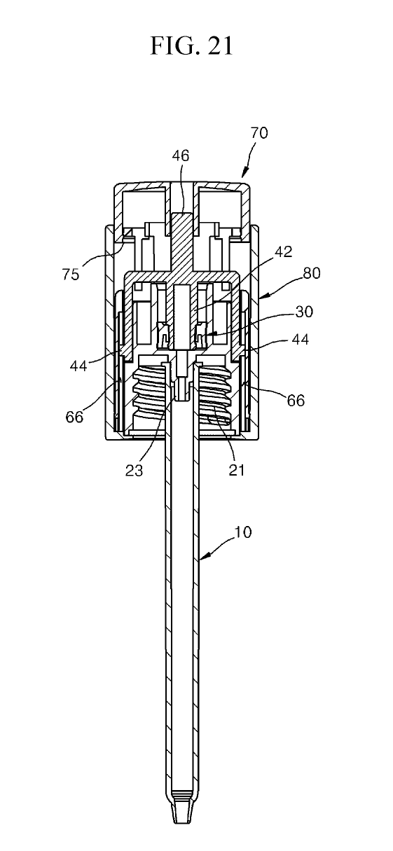

FIG. 1 is a perspective view of an apparatus for automatically filling a pipette according to a first embodiment of the present invention, FIG. 2 is a perspective view of the apparatus of FIG. 1, seen from under the apparatus, FIG. 3 is an exploded perspective view of FIG. 1, FIG. 4 is a front view of FIG. 1, FIG. 5 is a cross-sectional view taken along line A-A of FIG. 1, FIG. 6 is a right side view of FIG. 1, FIG. 7 is a cross-sectional view taken, along the line B-B of FIG. 6, FIG. 8 is a perspective view illustrating a state when an inner housing illustrated in FIG. 3 is coupled. FIG. 9 is another side perspective view of FIG. 8, FIG. 10 is a front view of FIG. 8, FIG. 11 is a cross-sectional view taken along line C-C of FIG. 10, FIG. 12 is a right side view of FIG 10. FIG. 13 is a cross-sectional view taken along line D-D of FIG. 12, FIG. 14 is a perspective view of a guide housing illustrated in FIG. 3. FIG. 15 is a perspective view of the guide housing of FIG. 14, seen from under die guide housing, FIG. 16 is a front view of FIG. 14. FIG. 17 is a cross-sectional view taken, along the line E-E of FIG. 16, FIG. 18 is a right side view of FIG. 14, FIG. 19 is a cross-sectional view taken along line F-F of FIG. 18, FIG. 20 is a first exemplary view illustrating operation of FIG. 5, and FIG. 21 is a second exemplary view illustrating operation of FIG. 5.

As illustrated in the figures, an apparatus for automatically filling a pipette according to an embodiment of the present invention, which is coupled to a container (not illustrated) through a threaded portion (not illustrated), includes: a pipette 10 that is filled with a substance; an inner housing 20 that is combined with the pipette 10, transmits a pressure change due to an operation force by a user to the pipette 10, is thread-fastened to the container, and has a cam contact portion on the outer side; a piston 30 that is combined with the inner housing 20 and provide a pressure change to the pipette 10 by moving up or down; a piston holder 40 that moves up or down the piston 30 by moving along the earn contact portion 50 by an operation force from a user; a guide housing 60 that is combined with the piston holder 40, guides the piston holder 40 up and down, and is rotated with the piston holder 40 by an operation force from a user such that the piston holder 40 interferes with the cam contact portion 50; a button 70 that is disposed over the inner housing 20, moves relatively to the piston holder 40, and presses the piston holder 40 by an operation force from a user; and a case 80 that receives the guide-housing 60 and transmits an operation force from a user to the guide housing 60.

The pipette 10 is formed in a pipe shape, and is inserted in the container and socks and keeps a substance, when being assembled.

The inner housing 20 includes: an inner body 22 having a thread 21 on the inner side; a pipette fixing portion 23 that is formed inside the inner body 22, fixes the pipette 10, and communicates with the piston 30; a piston moving portion 24 that is formed on the inner body 22, in which the piston 30 is inserted in close contact with it; and provides a pressure change to the pipette 10 when the piston 50 moves up or down; a holder guide portion 26 that is formed on the outer side of the inner body 22 and guides the piston holder 40 moving up and down in contact with it; and the cam contact portion 50 that interferes with the piston holder 40.

The inner housing 20 is formed entirely a cylindrical shape in this embodiment

The thread 21 that is thread-fastened to the container is formed on the inner side of the inner body 22.

The pipette fixing portion 32 communicates with the inner side of the pipette 10 and fitted in the pipette 10.

The piston 30 is inserted in the piston moving portion 24 in close contact with it, and when the piston 30 moves up or down, a pressure change is generated in the pipette 10.

The piston 30 is made of an elastic material and fixed to the piston holder 40 and a pressure space 35 is defined between the piston 30 and the piston moving portion 24.

The piston 30 provides pressure to the pipette 10 by moving up and down in the piston moving portion 24 and a substance in the pipette 10 is discharged by the pressure.

The cam contact portion 50 has a height difference in contact with the piston holder 40, so it vertically guides the piston holder 40 when it rotates with respect, to the piston holder 40.

The cam contact portion 50 has an upward contact portion 52 formed on the outer side of the inner body 22 a downward contact portion 54 formed on the outer side of tire inner body 22, and an inclined portion 56 connecting the upward contact portion 52 and the downward contact portion 54.

The upward contact portion 52, downward contact portion 54, and inclined portion 56 support a contact bar 45 at the lower end of the piston holder 40 and can move up or down along the cam contact portion in relative rotation.

In this embodiment, the cam contact portion 50 moves the piston holder 40 upward by moving to the downward contact portion 54, the inclined portion 56, and the upward contact portion 52 in relative rotation.

Meanwhile, the upward contact portion 52 is formed in an undercut shape recessed downward to lock the contact bar 45 and generates predetermined locking when being horizontally rotated in a state of locating at the upward contact portion 52.

The piston holder 40 includes a holder body 42 where the piston 30 is fixed, the contact bar 45 that radially extends from the holder body 42 and interferes with the can contact portion 50, and an indicator 46 that protrudes toward the button 70 from the holder body 42.

The contact bar 45 is bent in an L-shape from the holder body 42 and disposed on the outer side of the inner body 22.

Herein, the lower end of the contact bar 45 interferes with the cam contact portion 50 and a guide protrusion 44 guided with interference with the guide housing 60 is formed on the contact bar 45.

The button 70 is disposed over the piston holder 40 and has an exposing hole 72 so that the indicator 46 is exposed in accordance with the vertical position of the button 70.

Herein, the lower end of the button 70 can move up and down along the guide housing 60, and the upper portion of the indicator 46 is exposed through the exposing hole 72 only when the button 70 is moved to the lowermost position. Accordingly, a user can see the lowermost end of the button 70 through the indicator 46 and can recognize, that the substance in the pipette 10 cannot be discharged.

The guide housing 60 includes a guide body 62 that is coupled to the case 80, a button guide hole 64 that is formed in the guide body 62 to guide the button 70, and a piston rail 66 that is formed on the guide body 62 and guides the guide protrusion 44 of the piston holder 40 moving op and down.

Teeth 61 for coupling to the case 80 are formal on the guide body 62, and when the guide body 62 and the case 80 are combined and the case 80 is rotated, the guide body 62 is also rotated with the case 80.

An insertion end 75 of the button 70 is inserted in the button guide hole 64 and moves up and down in the button guide hole 64.

The guide protrusion 44 is disposed in the piston rail 66 and the piston holder 40 can move up and down along the piston rail 66.

As the guide protrusion 44 and the piston tail 66 are combined, the guide housing 60 and the piston holder 40 are integrally rotated in horizontal rotation and the piston holder 40 only vertically move along the guide housing 60.

Operation of the apparatus for automatically filling a pipette according to the first embodiment of the present invention is described in detail with reference to the drawings.

First, the state when, the pipette 10 is filled with a substance is illustrated in FIG, 5. When a user moves the piston holder 40 down by pressing the button 70, pressure corresponding to the movement of the piston holder 40 is transmitted to the inside of the pipette 10 and the substance in the pipette 10 is discharged.

In this case, as illustrated in FIG. 9, the contact bar 43 of the piston holder 40 is moved from the position \hat{1} to the position \hat{1}.

Next, a case of filling the pipette 10 with a substance is described.

A user moves the apparatus to a container and then fixes the apparatus to the container through thread-fastening, and while the thread 21 of the inner body 22 and the thread of the container are coupled, the entire apparatus is rotated, and thread-fastening is finished, the piston holder 40 is rotated along the cam contact portion 50 by an operation force from a user.

In this process, the case 80 and the guide housing 60 are combined with each other and the guide housing 60 and the piston holder 40 are combined for horizontal rotation, so when the case 80 is totaled by an operation force from a user, the piston holder 40 is also rotated horizontally.

In more detail, the case 80 and the guide housing 60 are combined by the teeth 61 and integrally rotated horizontally, and the guide protrusion 44 of the piston holder 40 is disposed in the piston rail 66, so when horizontal rotation is generated, it is locked to the piston rail 66 and rotates with the guide housing 60.

Accordingly, when the piston holder 40 is rotated by the operation force, the contact bar 45 of the piston holder 40 is moved to the upward contact portion 52 at the position \hat{2} along the inclined portion 56 from the downward contact portion 54 at the position \hat{3}.

In this process, the piston holder 40 generates negative pressure in the pipette 10 by moving upward along the inclined portion 56, so the pipette is filled with the substance in the container.

Accordingly, as described above, while a user locks the pipette, the substance in the container is sucked and thus filled into the pipette 10.

Thereafter, when a user separates the apparatus from the container to use the substance, the threaded-fastening is removed and the case 80 is rotated to be loosened, the contact bar 45 of the piston holder 40 is moved from, the position \hat{2} to the position \hat{3}.

The piston holder 40 that has moved to the position \hat{3} can discharge the substance by moving down along the piston rail 66.

Meanwhile, since the piston holder 40 and the button can vertically move relatively to each other, when the indicator 46 is not exposed through the exposing hole 72, a user can directly recognize that the pipette is not tided with the substance.

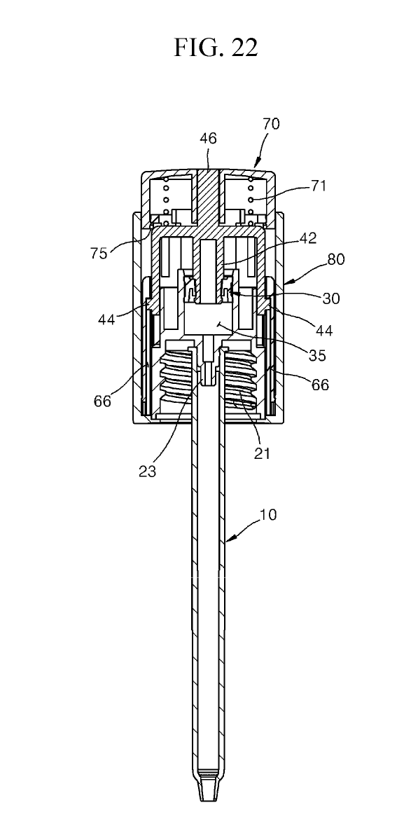

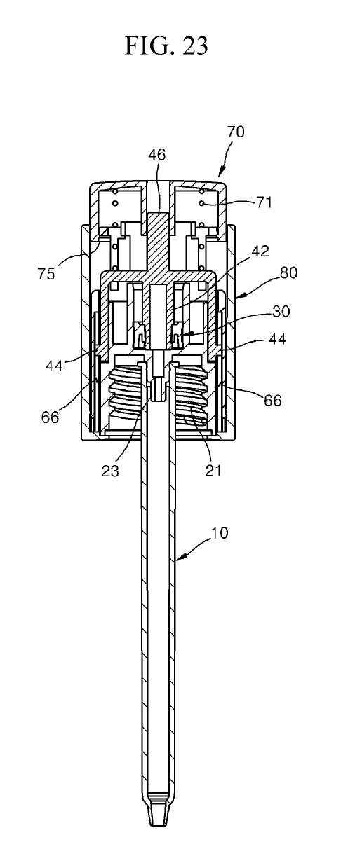

FIG. 22 is a cross-sectional view of an apparatus for automatically filling a pipette according to a second embodiment of the present invention and FIG. 23 is an exemplary view illustrating operation of FIG. 22.

As illustrated, in the figures, an apparatus for automatically filling a pipette according to this embodiment is the same as the first embodiment, except that an elastic member 71 is further disposed between the holder body 42 and the button 70.

Accordingly, when an operation force from a user is not applied to the button 70, the button 70 is spaced from the holder body 42 by elastic force of the elastic member 71.

As illustrated in FIG. 22, when the pipette 10 is filled with a substance, the holder body 42 is moved up and the indicator 46 is exposed through the button 70.

Further, when a user presses the button 70 and the substance in the pipette 10 is discharged, as illustrated in FIG. 23, the button 70 is moved up by the elastic member 71 and the indicator 46 is not exposed.

Accordingly, when the substance is discharged from the pipette 10, a user can more directly recognize whether the pipette is filled with the substance through the indicator 46.

Although a coil spring is used as the elastic member in this embodiment, elastic member made of various materials in various shapes and having elasticity such as leaf spring or rubber may be used.

The other configuration is the same as that of the first embodiment, so it is not described in detail.

Although exemplary embodiments of the present invention were described above with reference to the accompanying drawings, the present invention is not limited thereto and those skilled in the art would understand that the present invention may be implemented in various ways without changing the necessary features or the spirit of the prevent invention. Therefore, it should be understood that the exemplary embodiments are no limiting but illustrative all aspects.

1. An apparatus for automatically filling a pipette that is thread-fastened to a container keeping a substance, the apparatus comprising:
a pipette (10) that is filled with a substance;
an inner housing (20) that is combined with the pipette (10), transmits a pressure change due to an operation force by a user to the pipette (10), is thread-fastened to the container, and has a cam contact portion (50) on the outer side;
a piston (30) that is combined with the inner housing (20) and provide a pressure change to the pipette (10) by moving up or down;
a piston holder (40) that moves up or down the piston (30) by moving along the cam contact portion (50) by an operation force from a user; and
a guide housing (60) that is combined with the piston holder (40), guides the piston holder (40) up and down, and is rotated with the piston holder (40) by an operation force from a user such that the piston holder (40) interferes with the cam contact portion (50).

2. The apparatus of claim 1, wherein the cam contact portion (50) has:
an upward contact portion (52) formed on the outer side of the inner housing (20) and interfering, with the piston holder (40) in contact with the piston holder (40); a downward contact portion (54) formed on the outer side of the inner body, interfering with the piston holder (40) in contact with the piston holder (40), and disposed under the upward contact portion (52); and
an inclined portion (56) connecting the upward contact portion (52) and the downward contact portion (54).

3. The apparatus of claim 2, wherein undercut generating horizontal rotation locking of the piston holder (40) is further farmed concavely on at least any one of the upward contact portion (52) and the downward contact portion (54).

4. The apparatus of claim 1, wherein the piston holder (40) includes a holder body (42) that relatively vertically moves with the button (70) and where the piston (30) is fixed, the contact bar (45) that radially extends from the holder body (42) and interferes with the cam contact portion (50), and an indicator (46) that protrudes through the button (70) from the holder body (42).

5. The apparatus of claim 4, wherein the piston holder (40) further has a guide protrusion (44) for coupling to the guide housing (60),
the guide protrusion (44) relatively moves vertically along the guide housing (60) when operation by a user is provided vertically to the piston holder (40), and
when the piston holder (40) is horizontally rotated by an operation force from the user; the guide protrusion mutually locks the guide housing (60) and integrally rotates with the guide housing (60).

6. The apparatus of claim 1, wherein, the inner housing (20) includes:
an inner body (22) that is thread-fastened to the container by a thread (21) on the inner side;
a pipette fixing portion (23) that is fanned inside the inner body (22), fixes the pipette (10), and communicates with the piston (30);
a piston moving portion (24) that is formed on the inner body (22), in which the piston (30) is inserted in close contact with the piston moving portion (24), and provides a pressure change to the pipette (10) when the piston (30 ) moves up or down;
a holder guide portion (26) that is formed on the outer side of the inner body (22) and guides the piston holder (40) moving up and down in contact with the piston bolder; and
the cam contact portion (50) that interferes with the piston holder (40) when being rotated by an operation force from a user.

7. The apparatus of claim 1, wherein die guide housing (60) includes:
a guide body (62) that is combined with the ease (80); and
a piston rail (66) that is formed on the guide body (62), guides the piston holder (40) vertically moving, and locks horizontal rotation of the piston holder (40) for integral rotation with the piston holder (40).

8. An apparatus for automatically filling a pipette that is thread-fastened to a container keeping a substance, the apparatus comprising:
a pipette (10) that is filled with a substance;
an inner housing (20) that is combined with the pipette (10), transmits a pressure change due to an operation, force by a user to the pipette (10), is thread-fastened to the container, and has a cam contact portion on the outer side;
a piston (30) that is combined with the inner housing (20) and provide a pressure change to the pipette (10) by moving up or down;
a piston holder (40) that moves up or down the piston (30) by moving along the cam contact portion (30) by an operation force from a user;
a guide housing (60) that is combined with the piston holder (40), guides the piston holder 40 up and down, and is rotated with the piston holder (40) by an operation force from a user such that the piston holder (40) interferes with the cam contact portion (50);
wherein cam contact portion (50) has an upward contact portion (52) formed on the outer side of the inner housing (20) and interfering with the piston holder (40) in contact with the piston holder (40); a downward contact portion (54) formed on the outer side of the inner body; interfering with the piston holder (40) in contact with the piston holder (40), and disposed under the upward contact portion (52); and an inclined portion (56) connecting the upward contact portion (52) and the downward contact portion (54).
the piston holder (40) includes a holder body (42) that relatively vertically moves with, the button (70) and where the piston (30) is fixed, the contact bar (45) that radially extends from the holder body (42) and interferes with the cam contact, portion (50), an indicator that protrudes through the button (70) from the holder body (42), and a guide protrusion (44) for coupling to the guide housing (60); and
the guide protrusion (44) relatively moves vertically along the guide housing (60) when operation from a user is vertically provided to the piston holder (40), and the guide protrusion integrally rotates with the guide housing (60) by mutually locking the guide housing (60) when the piston holder (40) is horizontally rotated by an operation force from a user.

9. The apparatus of claim 8, wherein the inner housing (20) includes: an inner body (22) that is thread-fastened to the container by a thread (21) on the inner side; a pipette fixing portion (23) that is formed inside the inner body (22), fixes tire pipette (10), and communicates with the piston (30); a piston moving portion (24) that is formed on the inner body (22), in which the piston (30) is inserted in close contact with the piston moving portion (24), and provides a pressure change to the pipette (10) when the piston (30) moves up or down; a holder guide portion (26) that is formed on the outer side of the inner body (22) and guides the piston holder (40) moving up and down in contact. With the piston holder; and the cam contact portion (50) that interferes with the piston holder (40) when being rotated by an operation force from a user, and
the guide housing (60) includes: a guide body (62) that is combined with the case (80); and a piston rail (66) that is formed on the guide body (62), guides the piston holder (40) vertically moving, and locks horizontal rotation of the piston holder (40) for integral rotation with the piston holder (40).
